(19) United States
(12) Patent Application Publication
(10) Pub. No.: US 2025/0173672 A1
(43) Pub. Date: May 29, 2025

(54) SIMULATION SERVICE MODEL FOR INVENTORY OPTIMIZATION

(71) Applicant: Oracle International Corporation, Redwood Shores, CA (US)

(72) Inventors: Amir Hossein Rezaeian, San Jose, CA (US); Afshin Oroojlooyjadid, Hellertown, PA (US)

(21) Appl. No.: 18/523,710

(22) Filed: Nov. 29, 2023

(51) Int. Cl. G06Q 10/087

(52) U.S. Cl. CPC G06Q 10/087

(57) ABSTRACT

Techniques for inventory optimization using a simulation service model are provided. In one technique, a first optimization technique is used to generate, based on demand data, first output that comprises a first plurality of output values, each value corresponding to a node in a multi-echelon system. While using the first optimization technique, a plurality of variable values, each variable value corresponding to a node in the multi-echelon system, is generated. Then, a second optimization technique that is different than the first optimization technique is used to generate, based on the demand data and the plurality of variable values, second output that comprises a second plurality of output values, each value corresponding to a node in the multi-echelon system.

### TECHNICAL FIELD

The present disclosure relates generally to computer simulations and, more particularly, to new techniques for simulating activities to optimize inventory in multi-echelon systems.

### BACKGROUND

Operations research (OR) is an analytical method of problem-solving and decision-making that is useful in the management of organizations. In OR, problems are broken down into basic components and then solved in defined steps by mathematical analysis. OR involves different use cases, such as routing optimization, resource allocation, scheduling, and inventory optimization. For example, inventory management is an important challenge for many enterprises. Complexity of inventory control increases when a supply chain contains more than one echelon (or stage) of procurement, manufacturing, production, transportation, and/or storage with stochastic components. For example, it is not obvious how to allocate safety stocks in multi-echelon inventory systems to meet target service levels at the lowest cost under external demand uncertainty.

Example approaches to solve these types of use cases include integer or mix-integer programming, linear programming, stochastic programming, dynamic programming, simulation optimization, and reinforcement learning.

Among these approaches, simulation optimization (SO) is one of the most common approaches and may be used for many use cases for which other approaches are not even applicable. SO can be broken down into two parts: first, using simulation, all feasible pipelines or scenarios representing different stages in a system are built by computing all costs and other relevant characteristic parameters. Then, in the optimization part, the model scans all possible solutions and, given an objective function (such as cost and/or service level), attempts to find the optimal solution.

However, the main challenge for SO is that in many (if not most) real-world use cases, the solution-space of decision variables is large (with several possible values for each variable and their combinations) and, therefore, it is computationally expensive (and sometimes impossible) to explore all different combinations and compare their associated objective functions. There are a few approaches which attempt to improve the optimization strategies. However, all of these approaches heavily rely on their input from the simulation part and, in many cases, there is no guarantee for finding the optimal solution.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example inventory optimization (IO) framework;

FIG. 2A is an example of a more complex topology relative to the topology in FIG. 1;

FIG. 2B is an example where there are multiple items associated with each node in the more complex topology;

FIG. 3 is a block diagram that depicts an example system for generating supply solutions for a supply chain management system, in an embodiment;

FIG. 4 is a flow diagram that depicts an example process for inventory optimization using GSM and SO techniques, in an embodiment;

FIG. 5 is a block diagram that illustrates a computer system upon which an embodiment of the invention may be implemented;

FIG. 6 is a block diagram of a basic software system that may be employed for controlling the operation of computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview of Guaranteed Service Model

Guaranteed service model (GSM) is another approach that can be implemented in the supply chain management space and is an alternative to SO. In the GSM approach, each echelon promises a guaranteed service to its downstream echelons. However, for the purpose of rendering the service time guarantee, demand is assumed to be bounded instead of being unbounded. The guaranteed nature of the service times assures that the replenishment times between echelons are deterministic. Thus, the challenge is to determine the best service times for each echelon to minimize the total inventory cost of the supply chain, subject to final customer service requirements.

A benefit of GSM over SO is that GSM solutions are less computationally expensive and take much less time to complete. However, GSM solutions are often sub-optimal due to the fact that GSM does not consider the entire search space of solutions.

### General Overview

A system and method of implementing a simulation service model for inventory optimization are provided. In one technique, SO and GSM approaches are combined to discard or reduce the respective disadvantages and obtain the respective advantages. Specifically, the two approaches are combined in such a way to reduce the latency of computation significantly (e.g., 10×) relative to SO and improve the model solutions relative to GSM. For example, model solutions are improved by minimizing average on-hand inventory while maintaining desired average service-level at stocking locations in a supply-chain network. Embodiments also build more effective what-if scenarios for inventory optimization.

### Inventory Optimization

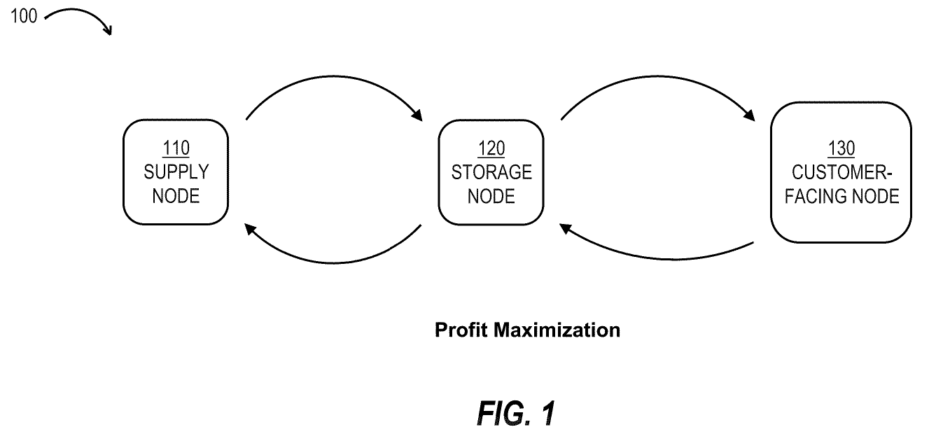

The optimization of supply chain management and inventory management is referred to herein as “inventory optimization.” FIG. 1 is a block diagram that depicts an example inventory optimization (IO) framework 100. There are three nodes or stages: a production node 110 (where goods are produced based on two or more inputs), a storage node 120 (representing an intermediate storage site where produced goods from the production node are temporarily stored), and a customer demand node 130 (where produced goods are purchased).

There are at least four considerations in IO: objective (e.g., maximizing profits), questions (e.g., how much to order and when to order), inventory drivers (e.g., supply, costs, demand, and lead time), and costs (purchasing, transaction/transportation, holding, expiration, and storage).

Different costs are associated with different nodes. For example, production node 110 is associated with purchasing costs of inputs that are needed to make one or more products. Storage node 120 is associated with holding costs, which is the cost of holding or storing goods at a particular location. The greater the number of goods to store, the higher the holding costs. Storage node 120 is associated with expiration costs, which is the cost of disposing of goods that have expired. Customer demand node 130 is associated with shortage costs, which is the cost of not having enough goods to meet demand.

Each adjacent node in the inventory system (or supply chain) may be thought of as having a connection or edge, which may have attributes, such as costs or lead time. For example, the edge between production node 110 and storage node 120 is associated with transaction costs of transporting goods to storage node 120. That edge is also associated with lead time data (i.e., the time it takes for an item/product/good to move from one node or location to another). Lead time data may be an average lead time or average lead time over time. The lead time indicates the reliability of production node 110. (Suppliers of inputs to production node 110 may also be associated with lead time information.) The edge between storage node 120 and customer demand node 130 is associated with demand data, such as demand distribution data that indicates actual or predicted demand over time.

A goal of IO is to optimize (or minimize) the costs (or maximize profit) in order to meet demand at the last or terminal node, which is customer demand node 130 in this example. In order to optimize the costs, the questions of how much to order at every node and when to order are considered in order to meet the demand to maximize the profit.

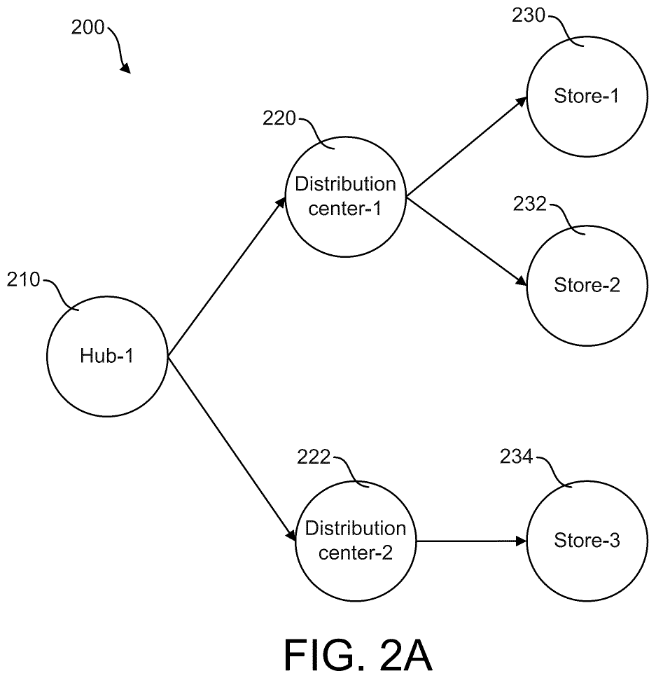

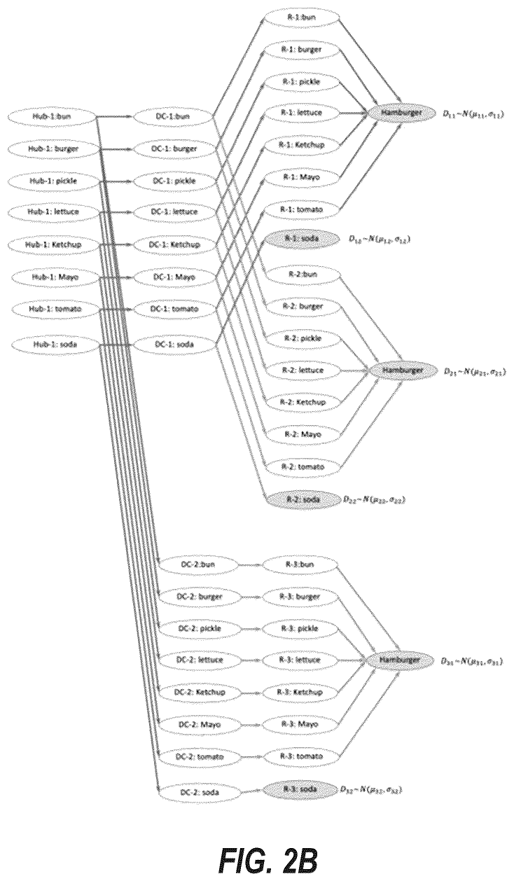

The example IO framework in FIG. 1 is a simple topology and involves only a single item. In contrast, real-world topologies are much more complex, at least in terms of number of nodes and connections. FIG. 2A is an example of a slightly more complex topology 200 (relative to the topology in FIG. 1) that includes a hub 210, distribution centers 220 and 222, and stores 230, 232, 234.

FIG. 2B is an example where there are multiple items associated with each node in topology 200. The ovals with “Hub-1” in the name correspond to hub 210, the ovals with “DC-1” in the name correspond to distribution center 220, the ovals with “DC-2” in the name correspond to distribution center 222, the ovals with “R-1” in the name correspond to store 230, and so forth. In this example, stores 230-234 sell hamburgers and sodas and each hamburger is made up of multiple ingredients or items, such as buns, burgers, ketchup, pickles, lettuce, mayonnaise, etc. Each item may be accounted for when computing an optimal (or semi-optimal) solution involving how much of each item to order at one or more nodes and when to order that item.

### System Overview

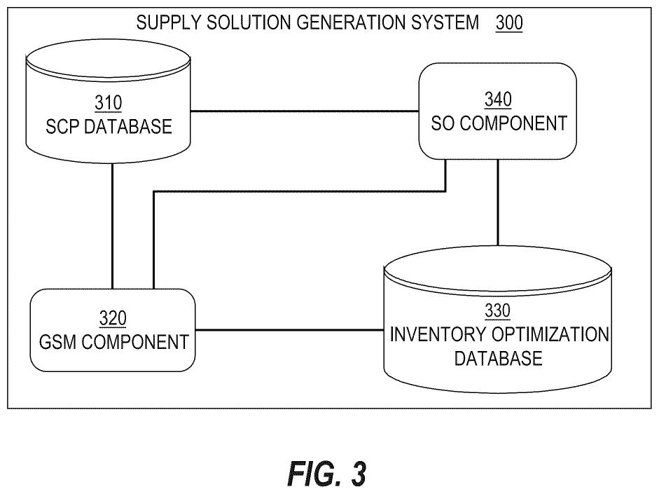

FIG. 3 is a block diagram that depicts an example system 300 for generating supply solutions for a supply chain management system, in an embodiment. System 300 comprises a supply chain planning (SCP) database 310, a Guaranteed Service Model (GSM) component 320, an inventory optimization database 330, and a Simulation Optimization (SO) component 340. SCP database 310 stores demand planning data 312, which is provided to GSM component 320 in order to generate, based on demand planning data 312, a solution space regarding supply values. SCP database 310 also stores supply planning data 314, which is generated and provided by SO component 340 based on the solution space generated by GSM component 320. Each of GSM component and SO component may be implemented using one or more computing jobs.

A user or administrator of system 300 may input values into system 300, which values are used to generate demand planning data 312. The input values may be time series data, in which case the demand planning data 312 is a copy thereof. (For example, the time series data may be actual demand values in a previous time period, such as a month or a year, and are assumed to be fairly accurate demand values in the next time period.) Alternatively, the input values may be a function that defines a demand curve over time.

At least one demand value exists for each node or entity in a multi-echelon supply chain management system, or inventory system. A node corresponds to a physical location where goods and/or services are performed, processed, stored, and/or transmitted. For example, a first node may be a factory in Indonesia, a second node may be a distribution center in Seattle, and a third node may be a retail establishment in Houston. A supply chain management system may include multiple factories, multiple distribution centers, and/or multiple store fronts or retail establishments.

In an embodiment, GSM component 320 requests demand planning data 312 from SCP database 310. Other non-demand data (such as costs, lead time, etc.) is also input to GSM component 320. GSM component 320 comprises a model that analyzes demand planning data 312 (and other input values) and generates output (or solution), comprising safety stock values, as described in more detail herein. GSM component 320 stores the variable values (that result in producing the output) in inventory optimization database 330. (GSM component 320 may also store the output (or safety stock values) to SCP database 310 as supply planning data 314. GSM component 320 notifies (e.g., through an API call) SO component 340 when GSM component 320 completes, or generates the output. In response to receiving the notification, SO component 340 retrieves the variable values from inventory optimization database 330 and generates a solution based on the variable values. Before generating the solution, SO component 340 (or another component, such as GSM component 320) modifies some of the variable values that were generated by GSM component 320, which modification is described in more detail herein. SO component 340 stores its output in SCP database 310 as supply planning data 314. Thus, supply planning data 314 may comprise output from both GSM component 320 and SO component 340. In this way, it can be measured how different the outputs are and how much savings (or profit) could be achieved using the GSM-SO integration embodiments described herein.

In an embodiment, although SO component 340 begins after the GSM component 320 completes, these two stages can also be done in parallel by dividing the phase spaces by sub-domain.

### GSM

One idea of the GSM approach is that each node j in a multi-echelon inventory system quotes a guaranteed service time T_j, by which this node (e.g., location/facility) will satisfy the demands from its downstream customers (whether internal or external). In other words, the customer demand at time t must be ready to be shipped by time t+T_j.

In the GSM approach, each echelon in the supply chain system maintains a safety stock to cover the demand during its replenishment time. Even if the processing time at the echelon/node is deterministic, the replenishment times between echelons become stochastic due to the occasional stock-outs caused by demand uncertainty.

Guaranteed service times for internal customers are decision variables to be optimized, while the guaranteed service time for the nodes at the last echelon (facing external customers) is an exogenous input, which may be set by the marketplace. In a multi-echelon inventory system, the GSM aims at determining the optimal placement and amount of safety stocks that ensures a target service level at the lowest cost. This model assumes that demand is bounded at each stage of the considered supply chain where demand bounds are usually obtained on the basis of a target Cycle-Service-Level (CSL).

As noted herein, the GSM approach assumes that demand is bounded within a given threshold and guarantees to satisfy that demand within a promised service time Sⱼ on node j. Any demand beyond that threshold needs to be satisfied with third-party sources. Node j is also associated with inbound service time SIⱼ, which is the necessary time to receive all inputs (e.g., components and material) from the node's predecessor node i in order to process a task at node j.

Since a node cannot start its process unless all necessary materials have arrived at the node, SIⱼ≥Sᵢ for all (i, j) in A, where A is the set of arcs in the multi-echelon network. If node j receives an order at time t, then, given the inbound service time and process time, the order will be ready at time t+SIⱼ+Lⱼ, where Lⱼ is the lead time and represents the duration of the process realized at stage j given that all necessary components are available. Lⱼ may also include the processing time for preparing an item at that echelon and also involves the transportation times to place the processed item into inventory. It may be assumed that there are no capacity constraints regarding physical space or the volume of work. A classic GSM approach assumes that lead times are known and constant for each stage. (“Node,” “echelon,” and “stage” are synonyms.)

The outbound service time is Sⱼ, therefore, the promise to the customer (or downstream requester) is to have the order ready by the time t+Sⱼ. If SIⱼ+Lⱼ≤Sⱼ, then the demand will be satisfied, but may result in a long service time. If Sⱼ≤SIⱼ+Lⱼ, then a safety stock with size (SIⱼ+Lⱼ−Sⱼ)*dⱼ is needed to cover the demand at τⱼ=SIⱼ+Lⱼ−Sⱼ, where dⱼ is the demand at that time. To provide the guaranteed service time, the base stock may be set to the upper bound at time interval τⱼ. Thus, Bⱼ=Dⱼ(τⱼ), where Dⱼ is the function which returns the upper bound of demand at time period τⱼ. Finally, the safety stock may be determined based on the following formula: Dⱼ(SIⱼ+Lⱼ−Sⱼ)−(SIⱼ+Lⱼ−Sⱼ)*μⱼ, where μⱼ is the mean demand at node j.

Regarding demand, it is assumed that historical demand or demand distributions at retailer (or external customer-facing) nodes D are available. For example, the mean and standard deviation μⱼ and Σⱼ are available for all nodes j in D. The demand for non-retailer nodes can be obtained by summing the mean demand for its downstream nodes.

Given the above, the problem may be modeled as the following Mixed Integer Programming/Linear Programming (MIP/LP) formulation:
a. min Σ_{jεN}hⱼ{Dⱼ(SIⱼ+Lⱼ−Sⱼ)−(SIⱼ+Lⱼ−Sⱼ)*μⱼ}, subject to:
b. Sⱼ−SIⱼ≤Lⱼ for all jεN
c. SIⱼ−Sⱼ≥0 for all (i, j)εA
d. Sⱼ≤sⱼ for all jεD (Sⱼ is service time while sⱼ is an upper bound limit for node j)
e. Sⱼ, SIⱼ≥0 for all jεN
   where SIⱼ and Sⱼ are the inbound and outbound guaranteed service times, respectively, for node j in the network, which are the main decision variables of the model. Additionally, Dⱼ(x) defines the maximum demand time at time x for node j, and μⱼ is the mean demand of node j. Lⱼ is the production time of node j.

If the demand is stationary, then the maximum demand function Dⱼ(x) may be defined as:

$${D}_{j} ( {τ}_{j} ) = {τ}_{j} {μ}_{j} + {k}_{j} {σ}_{j} \sqrt{τ j}$$

for the normally distributed demand, in which k is the inverse of the cumulative normal distribution for a given threshold. If the distribution is not stationary, then the distribution may be divided into time spans of stationary demand distributions:

$${D}_{j} ( t - {SI}_{j} - {L}_{j} , t - {S}_{j} ) = {\sum }_{τ = t - {SI}_{j} - {L}_{j} + 1}^{t - {S}_{j}} {μ}_{j} ( τ ) + {k}_{j} \sqrt{{\sum }_{τ = t - {SI}_{j} - {L}_{j} + 1}^{t - {S}_{j}} {σ}^{2} ( τ )}$$

The base stock also changes over time:

$${B}_{j} ( t - S {I}_{j} - {L}_{j} ) = {D}_{j} ( t - S {I}_{j} - {L}_{j} , t - {S}_{j} )$$

Nevertheless, it is not known whether the base stock policy is the optimal form of the policy; thus, finding the optimal parameters for the base stock policy does not signify that the global optimal policy is found.

The above is an example of a GSM model that may be used in embodiments. However, embodiments are not limited to the above formulation to modeling this problem.

### Integration of GSM and SO

In order to facilitate the integration of the simulation optimization (SO) and GSM approaches, the following steps may be taken, not necessarily in this particular order.

A discrete event (DE) simulation approach is employed in the simulation portion of the SO approach. DE simulation helps relate different stages of inventory with corresponding stages analyzed by the GSM model. In other words, DE simulation builds network that corresponds to what is available in the GSM solution. However, embodiments are not limited to DE simulation; rather, embodiments may involve other simulation approaches.

In an embodiment, a base stock policy is applied at each node for both the GSM and simulation optimization approaches. A base stock policy places a replenishment order to restore the base-stock S when the inventory position (stock on hand plus stock on order minus back-ordered) is below S. Therefore, the reorder point may be S−1. Again, however, embodiments are not limited to the base stock policy. Other stock policies may be used, such as a T policy or an S policy. In a related embodiment, instead of each node in a topology having the same stock policy, different nodes in a topology have different stock policies.

In an embodiment, the same network topology for supply chain management is used as the network topology in the GSM model and the SO model.

In an embodiment, the same mean of transportation between each pair of nodes in the GSM model and the SO model is used. For example, from node A (e.g., a regional distribution center) to node B (e.g., store), stocks are shipped only by truck, so we cannot have transportation by air or sea from node A to node B at the same time. However, another pair of C (e.g., manufacturer) to D (e.g., distribution hub) may ship only by sea. The reasoning behind this assumption is different means of transportation may have different lead-time statistical distribution, so they cannot be combined.

In an embodiment, serving an order from an external customer is prioritized over sending replenishment orders to internal nodes. In other embodiments, the different types of orders may be prioritized differently.

In an embodiment, if multiple replenishment orders exist in the pipeline from multiple requesting facilities, then the replenishment orders are fulfilled in the sequence in which the replenishment orders were received. Such a requirement simplifies finding a solution to the problem.

In an embodiment, a replenishment order is never partially shipped. If a stocking unit does not have enough on hand inventory, then the stocking unit waits until there is sufficient inventory to replenish the entire order volume. Such a wait adds to the downstream unit's lead time. In another embodiment, a replenishment order is allowed to be partially shipped. However, such an embodiment increases the complexity of the problem being solved.

An aim of GSM and SO is to minimize average on-hand inventory while maintaining desired average service-level at stocking locations. Some additional costs like ordering costs, shortage costs, and disposal costs may be available (i.e., known) in some enterprises, which may be added to the cost of inventory.

### Inputs and Outputs to a GSM Model and a SO Model

In an embodiment, the GSM model and the SO model have the following input variables/parameters that are the same: demand data (such as demand distribution (e.g., per item), which may be based on historical demand information), service level, capacity (e.g., maximum capacity per node), lead time data (such as lead time distribution (e.g., per node), which may be based on historical lead information), current inventory levels (per item per stage), current order values (per item per stage), sizes (per item or per package of items, which is used to determine current capacity), and costs, such as holding cost (per item), shortage cost (per item), disposal cost (per item), item level ordering cost (per item), and batch level ordering cost (per batch order). If some enterprises do not have one or more of these costs, then such costs are not considered during execution of the respective model. In a related embodiment, costs and item sizes are fixed values that do not change during execution of either model. For example, while service level and lead time may be pre-determined (e.g., lead time might have a probabilistic distribution), the inbound and outbound guaranteed service times for each stage (or equivalently the safety stock for each stage) are variables that the algorithm tests in order to determine their respective values.

In an embodiment, a user specifies input that comprises a range of values for the lead time variable at one or more nodes for the GSM model. Thus, if there are multiple nodes in a topology, the input may specify multiple value ranges, one for each of the multiple nodes. The larger the range of values, the longer it will take the GSM model to find a solution. In a related embodiment, the input indicates a single value for lead time of a node, where the single value represents an upper bound or limit, thus implying that the range is between 0 and that single value.

In an embodiment, the demand data is modified to fit the demand distribution to a parameterization that has a normal distribution. (In a related embodiment, a mean or median value for demand over a period of time may be calculated.) Such modified demand data becomes input to the GSM model. However, the requirement that the demand distribution follows a normal (or is a single fixed value) may be relaxed when inputting the demand data to the SO model.

In an embodiment, the definition of “service level” is different for GSM relative to SO. A value for service level for SO may be computed for each node based on guaranteed service level computed by the GSM model at the corresponding node, the safety stock, and one or more other variable values computed by the GSM model. Thus, GSM is first executed to obtain some initial values for the variables, including the inbound and outbound service levels. The overall service levels are also obtained at this stage. Then, SO is executed to obtain the updated values of the inbound and outbound service levels and the service level is calculated again. A goal in GSM is to obtain a service level larger than a certain threshold value while the total cost is minimized. Thus, at each time-step that the overall service level is obtained, the cost is also calculated.

In an embodiment, the GSM model and the SO model have the same output: safety stock per node. Thus, if there are multiple nodes, then the respective models produce a different safety stock value for each of the nodes. Also, if there are multiple items that may be stored at a node, then the respective models produce a different safety stock value for each item at that node.

### Simulation Optimization

Given the integration of GSM with SO, the following stages are different stages of an example SO pipeline.

First, the variables of an SO model are mapped and related to certain variables in the GSM framework. The result of running the GSM model is a set of variable values at each node in the multi-echelon network.

Second, the GSM model is executed to obtain the semi-optimal solutions. As noted herein, the GSM solutions assume that demand is bounded with a given threshold and guarantees to satisfy that demand within some promised service time Sⱼ on node j. Any demand beyond that threshold needs to be satisfied with third-party sources, which tend to be costly. Confidence intervals of the service level of any nodes are obtained and will be utilized later when the SO model is executed.

While the GSM model is executed, variables at each node, such as inventory level, service level, inventory costs, etc., are logged when the GSM optimal solution is obtained. (Service level (both the per node and overall service levels) and cost are changing with different values for the decision variables (i.e., inbound and outbound service levels), which are variables to be optimized. The inventory levels are also changing through the simulation; thus, their values are needed as a reference.) To save memory, a dictionary may be created with the name of nodes as a key and a sub-dictionary of (key-values) of inventory variables for the node. This dictionary is updated until the optimal solution (according to the GSM model) is obtained. This dictionary helps to reverse the problem and find the variables that provide the optimal values of the objective function. (“Reversing the problem” refers to determining the input values X ({x₁, x₂, . . . , xₙ}, which values are in the dictionary) that were used to produce the output, or f(X).) In this way, neither Newton's method nor gradient descent needs to be executed in order to obtain variables of the complex objective function, which variables are needed for the next step.

In an embodiment, for one or more non-fixed variables, confidence intervals are computed along with statistical uncertainties at one or more nodes. Thus, at least some non-fixed variables may be associated with a range of values defined by a single value and a confidence interval, such as “±1.5,” or “±3 sigmas” (or standard deviations from the mean).

The GSM solutions (embodied in the values of non-fixed variables in the dictionary) are used as initial seed for the SO model. (Also, fixed variables are also input to the SO model.) Given that semi-optimal solutions of the GSM model are available utilizing the dictionary of variables obtained in the previous step, the SO model is executed using a range of sigma values at each node, such as 3-10 sigmas. In this way, what-if scenarios may be formulated as part of obtaining optimal solution.

In an embodiment, the range of sigma values are automatically calculated. For example, the GSM model computes a single value of an input variable and then the SO model, or another process, computes a range of values or a confidence interval based on the single value that is ±3 sigmas from the single value. As another example, the GSM model computes a range of values of an input variable and then the SO model, or another process, increases or decreases the range of values based on a default confidence interval that is based on a certain number of sigmas. Increasing the range of values means that the uncertainty is greater, but the SO model will search more potential solutions.

When modifying a range of values or confidence interval, some rounding may be required. For example, determining an upper bound on a range of values based on four sigmas may result in a non-integer value (e.g., 41.4) when the corresponding variable must be a non-negative integer value. Thus, the non-integer value may be rounded to the next highest integer.

### Example Process

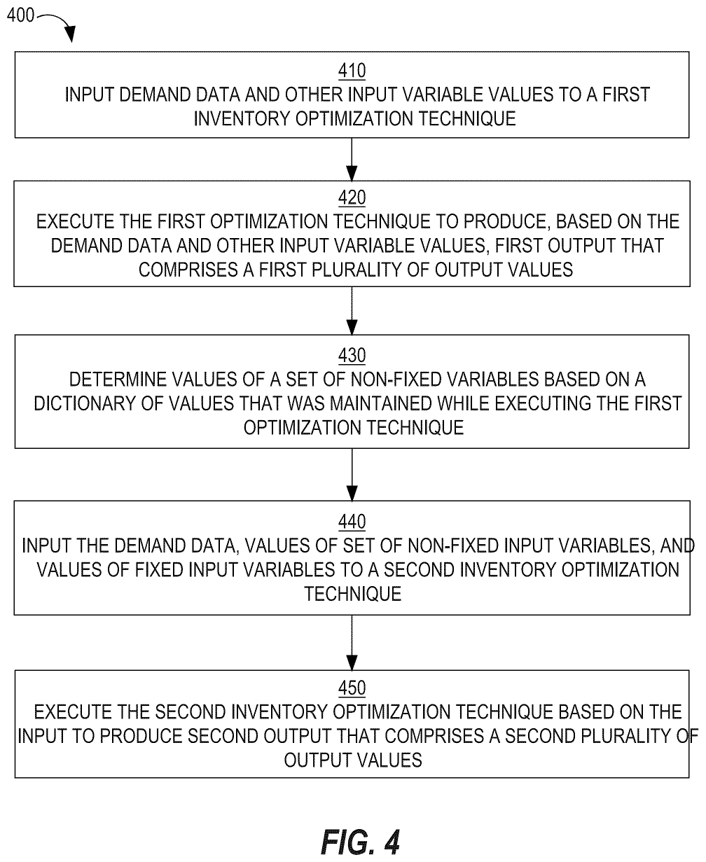

FIG. 4 is a flow diagram that depicts an example process 400 for leveraging two different inventory optimization techniques, in an embodiment. Process 400 may be performed by different elements of system 300.

At block 410, demand data and other input variable/parameter values are input to a first inventory optimization technique. An example of the first inventory optimization technique is the GSM technique. Some of the input variable values may be fixed values, such as fixed cost values, while other input variable values may be ranges, such as lead time. Additionally, some of the input variables may be node specific, while other input variables may be item specific, while other input variables may be item-node specific. Block 410 may involve GSM component 320 reading data from SCP database 310.

At block 420, the first inventory optimization technique is executed to produce, based on the demand data and the other input variable values, first output that comprises a first plurality of output values. An example of the first output is a safety stock value per node. Each node in the multi-echelon network represents a placeholder for one item on that location. In hamburger example, each ingredient of the hamburger is one node in each location. Therefore, each node is monitoring and optimizing the inventory of one single item.

At block 430, values of a set of the non-fixed input variables are determined based on a dictionary of values that was maintained for the first inventory optimization technique as that technique updated the dictionary. Examples of non-fixed input variables include lead time and service level. Block 430 may involve GSM component 320 writing this data to inventory optimization database 330.

At block 440, the demand data, the values of the set of non-fixed input variables, and values of fixed input variables (e.g., costs) are input to a second inventory optimization technique that is different than the first inventory optimization technique. An example of the second inventory optimization technique is the SO technique. As described herein, the demand data that is input to the second inventory optimization technique may be the same as, or different than, the demand data that is input to the first inventory optimization technique. Block 440 may involve SO component 340 reading demand data from SCP database 310 and other data from inventory optimization database 330.

Prior to block 440, one or more of the non-fixed variable values that were produced using the first inventory optimization technique are modified. A non-fixed variable value may comprise a single value or a range of values that represent a confidence level. Such modification may be to increase the range of values, decrease the range of values, or add a range of values for a single value.

At block 450, the second inventory optimization technique is executed based on the input to produce second output that comprises a second plurality of output values, an example of which is another set of safety stock values, at least one for each node. Block 450 may involve SO component 340 writing its output to SCP database 310.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

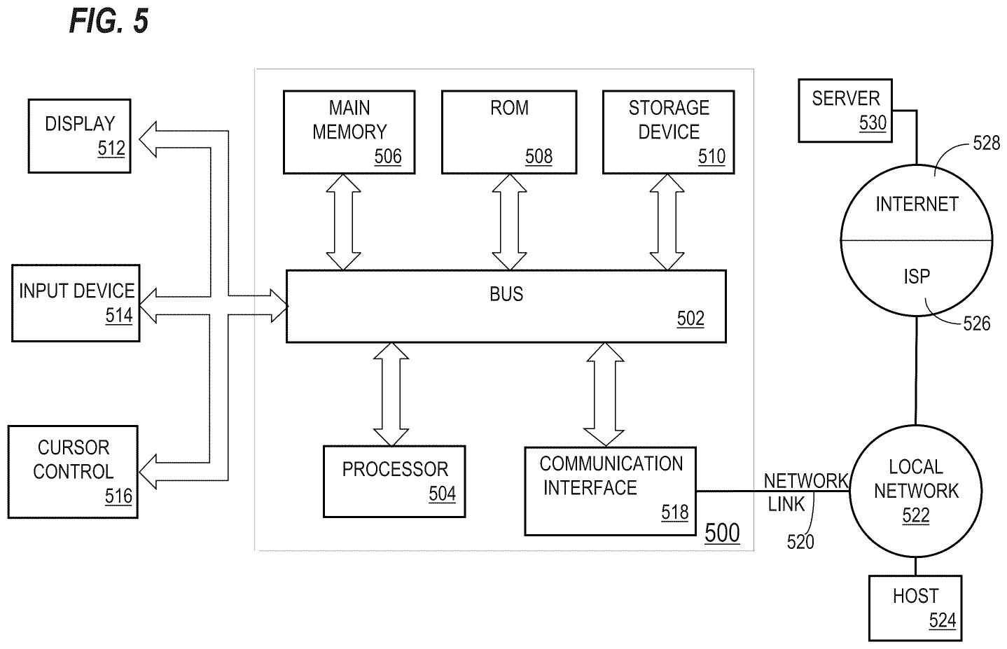

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

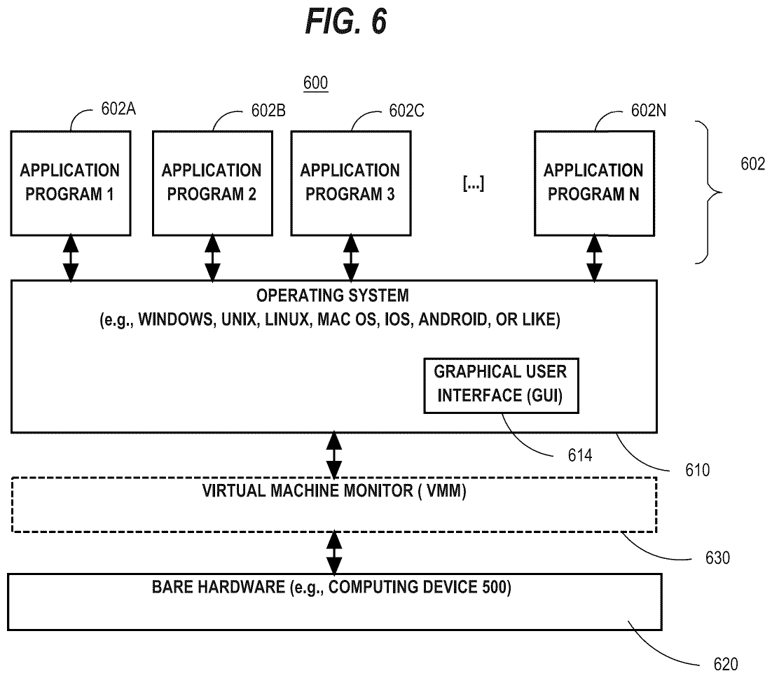

FIG. 6 is a block diagram of a basic software system 600 that may be employed for controlling the operation of computer system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computer system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (Saas), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating, based on demand data, using a first optimization technique, first output that comprises a first plurality of output values, each value corresponding to a node in a multi-echelon system;
while using the first optimization technique, generating a plurality of variable values, each variable value corresponding to a node in the multi-echelon system;
generating, based on the demand data and the plurality of variable values, using a second optimization technique that is different than the first optimization technique, second output that comprises a second plurality of output values, each value corresponding to a node in the multi-echelon system;
wherein the method is performed by one or more computing devices.

2. The method of claim 1, further comprising:
prior to using the second optimization technique, automatically modifying a confidence interval that is associated with a variable value in the plurality of variable values to generate a modified confidence level;
wherein the modified confidence interval is input to the second optimization technique.

3. The method of claim 1, further comprising:
prior to using the second optimization technique, automatically generating a confidence interval for a variable value in the plurality of variable values;
wherein the confidence interface is input to the second optimization technique.

4. The method of claim 1, wherein the demand data that is input to the first optimization technique is normalized demand data.

5. The method of claim 6, wherein second demand data that is input to the second optimization technique is a version of the demand data that is not normalized.

6. The method of claim 1, wherein a set of fixed costs are input to the first optimization technique and the second optimization technique.

7. The method of claim 1, wherein:
the multi-echelon system comprises a plurality of nodes;
each node in the plurality of nodes is associated with a different plurality of variable values that are being optimized.

8. The method of claim 1, wherein the first and second plurality of output values are safety stock values.

9. The method of claim 1, wherein the first optimization technique is a guaranteed service model.

10. The method of claim 1, wherein the second optimization technique is simulation optimization.

11. The method of claim 1, further comprising:
performing a comparison between the first plurality of output values and the second plurality of output values.

12. One or more non-transitory storage media storing instructions which, when executed by one or more computing devices, cause:
generating, based on demand data, using a first optimization technique, first output that comprises a first plurality of output values, each value corresponding to a node in a multi-echelon system;
while using the first optimization technique, generating a plurality of variable values, each variable value corresponding to a node in the multi-echelon system;
generating, based on the demand data and the plurality of variable values, using a second optimization technique that is different than the first optimization technique, second output that comprises a second plurality of output values, each value corresponding to a node in the multi-echelon system.

13. The one or more storage media of claim 12, wherein the instructions, when executed by the one or more computing devices, further cause:
prior to using the second optimization technique, automatically modifying a confidence interval that is associated with a variable value in the plurality of variable values to generate a modified confidence level;
wherein the modified confidence interval is input to the second optimization technique.

14. The one or more storage media of claim 12, wherein the instructions, when executed by the one or more computing devices, further cause:
prior to using the second optimization technique, automatically generating a confidence interval for a variable value in the plurality of variable values;
wherein the confidence interface is input to the second optimization technique.

15. The one or more storage media of claim 12, wherein the demand data that is input to the first optimization technique is normalized demand data.

16. The one or more storage media of claim 15, wherein second demand data that is input to the second optimization technique is a version of the demand data that is not normalized.

17. The one or more storage media of claim 12, wherein a set of fixed costs are input to the first optimization technique and the second optimization technique.

18. The one or more storage media of claim 12, wherein:
the multi-echelon system comprises a plurality of nodes;
each node in the plurality of nodes is associated with a different plurality of variable values that are being optimized.

19. The one or more storage media of claim 12, wherein the first optimization technique is a guaranteed service model and the second optimization technique is simulation optimization.

20. The one or more storage media of claim 12, wherein the instructions, when executed by the one or more computing devices, further cause:
performing a comparison between the first plurality of output values and the second plurality of output values.
